(19) United States
(12) Patent Application Publication
(10) Pub. No.: US 2004/0189464 A1
(43) Pub. Date: Sep. 30, 2004

(54) Methods and systems for performing search-and-rescue using a GPS transceiver

(75) Inventor: Harmeet S. Gill, Orangevale, CA (US)

Correspondence Address: Finnegan, Henderson, Farabow,, Garrett & Dunner, L.L.P., 1300 I Street, N.W., Washington, DC, 20005-3315, US

(73) Assignee: Maximus, Inc.

(21) Appl. No.: 10/396,600

(22) Filed: Mar. 26, 2003

(51) Int. Cl. G08B 1/08

(52) U.S. Cl. 340/539.13

(57) ABSTRACT

A system, method and computer-readable medium for performing a search operation are disclosed. In one embodiment, the method includes the step of establishing a wireless connection between at least one of a plurality of search-and-rescue devices and a server. Next, the method transmits data from a first search-and-rescue device to the server. Once the server receives the data, it processes the data, and then transmits a request to the first search-and-rescue device to alter a direction of travel, in response to the data received.

### DESCRIPTION OF THE INVENTION

1. Field of the Invention

The present invention relates to an apparatus and method for monitoring searchers during a search-and-rescue operation and for transmitting such information to a network-based server so that the information may be graphically depicted.

2. Description of the Related Art

Current news coverage is rife with examples of people who are lost or have been abducted, aircraft and marine craft lost at sea, mid-air collisions and explosions that result in scattered debris, and forest fires. All of these events have one thing in common, they require the mobilization of large groups of searchers to perform highly coordinated and systematic searches of potentially expansive geographic areas. Unfortunately, current search-and-rescue techniques are inadequate in three areas: they do not provide feedback of the path followed by each searcher back to a central location; they do not allow a coordinator at a central location to monitor/modify a search pattern of one or more searchers in real time; and they do not maintain detailed records of on-going and past search efforts.

Existing search concepts and systems abound. Those receiving the most attention require the use of emergency locator transmitters and the use of the Omega navigation system in conjunction with a synchronous relay satellite and ground computing and communication facilities. Both of these systems require the person who is lost or abducted to employ active receiver and/or transmitter devices after an emergency situation has developed. Also, they do not account for the situation in which the person being searched for is incapable of activating receiver/transmitter devices, or the situation in which the item being searched for is inanimate (e.g., aircraft part, gun, smoldering hot spot, etc.) In the past, large scale search-and-rescue operations that did not have the benefit of searching for a transmitted signal from a beacon required the coordinated effort of a group of searchers to comb through various types of terrain and vegetation. The imprecise nature of the task complicated an organizer's ability to track the progress or thoroughness of the search. Consequently, many of these searches resulted in the searchers overlooking key evidence, and/or completely bypassing potential search sites. For these reasons, there is a need for a method and system for performing search-and-rescue that allows a coordinator at a central location to monitor and direct the efforts of a large group of searchers in real time.

There is also a need for a system and method that allows a search coordinator to observe the on-going search efforts so that all areas are adequately searched, and no areas are searched repeatedly.

In addition, there is further a need to provide the capability to prepare and maintain accurate reports of the on-going search efforts so that a detailed and comprehensive report of the search activities can be communicated to the authorities.

### SUMMARY OF THE INVENTION

Systems, methods and computer-readable mediums consistent with the present invention satisfy the above-described need by providing a system, method and computer-readable medium for performing a search operation. In one embodiment, the method includes the step of establishing a wireless connection between at least one of a plurality of search-and-rescue devices and a server. Next, the method transmits data from a first search-and-rescue device to the server. Once the server receives the data, it processes the data, and then optionally transmits a request to the first search-and-rescue device to alter a direction of travel, in response to the data received.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary only and not restrictive of the invention as claimed.

### BRIEF DESCRIPTION OF THE DRAWINGS

The accompanying drawings, which are incorporated in and constitute a part of this specification, illustrate exemplary embodiments of the present invention and together with the description, serve to explain the principles of the invention. In the drawings,

FIG. 1 is a block diagram of the search-and-rescue device of the present invention in communication with a network-based server using a wireless communication system;

FIG. 2 is a block diagram of a preferred embodiment of a search-and-rescue device of the present invention;

FIG. 3 is a flowchart depicting the basic operational steps performed by a preferred embodiment of the device of the present invention;

FIG. 4 is a flowchart depicting operational steps of a server in accordance with the present invention as it conducts a search; and

FIG. 5 is a flowchart depicting the operational steps of a search-and-rescue device in accordance with the present invention when it receives a position update from a GPS satellite.

### DETAILED DESCRIPTION

In the following detailed description of a first embodiment, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limited sense.

Turning first to the nomenclature of the specification, the detailed description which follows is represented largely in terms of processes and symbolic representations of operations performed by conventional computer components, including a central processing unit (CPU), memory storage devices for the CPU, and connected pixel-oriented display devices. These operations include the manipulation of data bits by the CPU and the maintenance of these bits within data structures residing in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require logical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc., which are often associated with manual operations performed by a human operator. In other words, the operations described herein are machine operations performed in conjunction with a human operator or user who interacts with the computer. The machines used for performing the operation of the present invention include general purpose digital computers or other similar computing devices.

In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

The operating environment in which the present invention is used encompasses general distributed computing systems wherein general purpose computers, workstations, or personal computers are connected via communication links of various types. In a client server arrangement, programs and data, many in the form of objects, are made available by various members of the system.

For illustration purposes, aspects of the invention are described in the context of a search-and-rescue operation. These references are used throughout the description to provide examples of how aspects of a computer system according to the invention may be used to conduct a search-and-rescue. One of skill in the art will realize and appreciate that the present invention may be used in other search operations (e.g., search for “hot spots”, debris, evidence, etc.) without departing from the spirit and scope of the present invention.

The examples described in the text are often accompanied by figures illustrating user interface displays that may be produced through use of a computer system according to the invention to implement the virtual showroom. These too are illustrative and are not intended to limit the invention in any way.

Referring now to the drawings, in which like numerals represent like elements throughout the several figures, the present invention will be described.

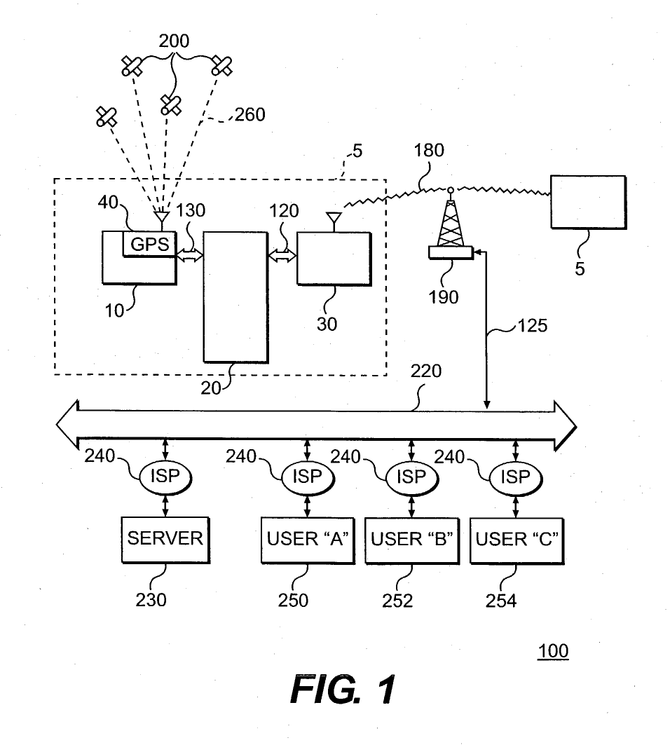

FIG. 1 depicts a data processing network 100 in which the present invention may be practiced. As shown network 100 includes a plurality of GPS satellites 200, a plurality of search-and-rescue devices 5, a wireless communications network 180, a public packet switched network 220, a plurality of user-terminals 250, 252 and 254, and at least one server 230. Search-and-rescue device 5 is further comprised of a first processing module 10, a second processing module 20, and a wireless communication system link 30. Processing module 10 is further comprised of a GPS receiver 40. Communication link 120 couples second processing module 20 to third processing module 30, and communication link 130 couples first processing module 10 to second processing module 20. Wireless communication network 180 is further comprised of mobile base antenna tower 190 and a high capacity communication line 125 for communicating with packet switched network 220. Wireless communication system 180 may be selected from the group of infrastructures that include wireless LAN/WAN (local area network/wide area network), AMPS (advanced mobile phone system), satellite based system communication, iDEN™, time division multiple access (TDMA), code division multiple access (CDMA), cellular digital packet data (CDPD) and global system for mobile communications (GSM) infrastructures. Network 220 may be implemented using any one or a combination of public packet switched network topologies, such as IEEE 802.3 Ethernet, IEEE 802.5 Token Ring, ITU X.25, or serial (SLIP) protocols, for example.

Search-and-rescue device 5 communicates with GPS satellites 200 through the use of GPS receiver 40. In operation, GPS receiver 40 receives radio signals over communication link 260 from positioning satellites 200 and derives time, position and operating condition information. Position information includes latitude, longitude, altitude and time at which the position information was obtained. Operating condition information includes the identities of the satellites 200 being employed for the calculation of position, their respective signal-to-noise ratios (SNRs), the orbital parameters of the satellites, and parameters indicating the probable uncertainty in the calculated position. Search-and-rescue device 5 communicates with other search-and-rescue devices 5, servers 230 and user terminals 250, 252 and 254 over wireless communication network 180.

Server 230 and user terminals 250, 252 and 254 are linked to network 220 via a communication link that includes an Internet Service Provider (ISP) 240. A communication link refers to any means for connecting two computing devices together, including Internet, Intranet, Extranet, ISDN, DSL, LAN and any future connection systems. The communication channel may be provided by wired lines such as cable, optical lines, or telephone lines. It may be connected to the computer by any commercially available format of communication such as COM port, parallel port, USB port, etc. In addition to connected wires, the communication channel may be in the form of a wireless channel such as RF and infrared channels. ISP 240 typically provides data communication through one or more networks or other devices. For example, the link may provide a connection to a local network (not shown) to a host computer (not shown) or to data equipment (not shown) operated by ISP 240. In one embodiment, ISP 240 provides data communication services through the worldwide packet data communications network now commonly referred to as the Internet. Those skilled in the art will appreciate that the server 230, and user terminals 250, 252 and 254 may be located a great geographic distance from network 220, which in turn, may be located a great geographic distance from tower 190 and search-and-rescue devices 5.

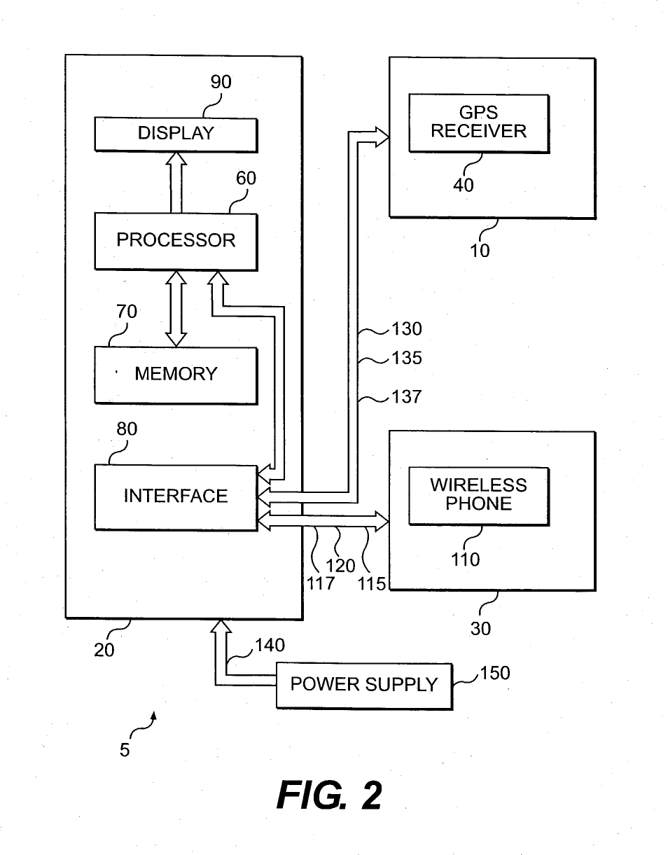

Referring now to FIG. 2, there is shown a more detailed diagram of search-and-rescue device 5 in accordance with one embodiment of the present invention. As shown, the second processing module 20 includes a processor 60, a memory 70, an interface 80 and a display 90. In one embodiment memory 70 may be an electrically erasable programmable read only memory (“EEPROM”) or, more generally, an electrically erasable programmable memory. Interface 80 may be at least one RS-232 driver, and display 90 may be a light emitting diode (“LED”) display. Wireless communication system link 30 may any means of wireless communication including a wireless telephone 110, a radio, etc.. In an exemplary embodiment of the present invention, wireless telephone 110 may be a web-enabled wireless telephone such as, for example, cellular CDMA, TDMA, or GSM telephones that support the Wireless Access Protocol (“WAP”) or i-Mode data access protocols for displaying web application information. In addition to transmitting data from device 5 to network 180, wireless telephone 110 is also configured to receive messages sent by server 230 and to direct those messages back to processor 60. This permits a user at server 230 or user terminals 250, 252 and 254, for example, to communicate messages like Internet Control Management Protocol Echo (“ICMP”) ping messages, configuration messages, or poll messages to wireless phone 110, which is configured to transmit those messages to processor 60. Wireless telephone 110 may also be removably attached to the second processing module 20 through a link 115. In an alternate embodiment, link 115 may be a wireless link between the second processing module 20 and the wireless communication system link 30. The wireless link may consist of a Bluetooth Chipset and built-in antenna housed within second processing module 20 and a compatible Bluetooth Chipset and built-in antenna housed within the wireless communication system link 30.

Power supply 150 provides power to second module 20 through power supply cable 140. Power may be supplied to wireless phone 110 through an on-board storage battery typical for wireless telephones, and power may be supplied to GPS receiver 40 through power conductor means 135 in cable 130. Data communication between first module 10 and second module 20 is provided through a data link 137 contained in cable 130, and data communication between third module 30 and second module 20 is provided through data link 117 contained in cable 120. Cable 120 may be a wireless interface or it may be hardwired (e.g., coaxial cable, copper wire, fiber optic, etc.)

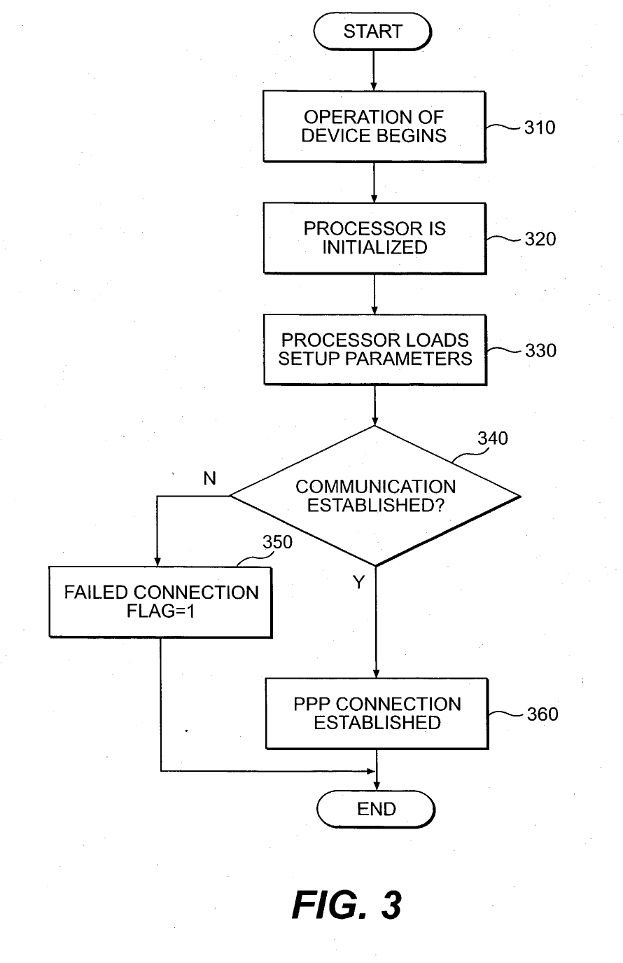

Turning now to FIG. 3, there is shown a flow chart that depicts the operation of search-and-rescue device 5 in accordance with one embodiment of the present invention. As shown, operation commences in step 310 when the device receives power from power supply 150, which is supplied to device 5 through power cable 140. Upon receiving power, processor 60 is initialized (step 320). Processor 60 then checks for the presence and functionality of all hardware contained in device 5, and then loads the setup parameters in memory 70 (step 330), which include the host IP and port address, the dial string, the ISP phone number, user name and password, and the time and distance reporting rates for search-and-rescue reporting. Following loading of setup parameters, device 5 attempts to establish a wireless connection over wireless communication system 180 to server 230 for automatic transmission and monitoring of position data (step 340). If a communication link is established, processing flows to step 360. If a communication link is not established, processing flows to step 350. In step 360, a point-to-point protocol (“PPP”) connection is established between second module 20 and wireless phone 110 using a packet data or circuit-switched connection depending on the wireless communications system 180. Processing then terminates. In step 350, a failed connection flag is set before terminating processing. In one embodiment, once a communication link is established, it is continuously maintained as long as device 5 is powered on. In a second embodiment, device 5 attempts to establish a new connection with wireless network 180, each time it seeks to transmit a position update to server 230. When the position update is received at server 230, then device 5 terminates the connection. In this way, a minimum amount of wireless network time will be utilized.

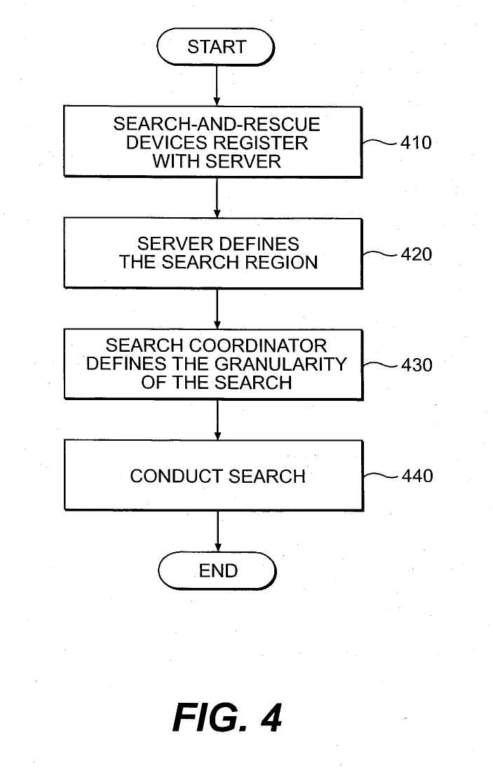

Referring now to FIG. 4, there is shown a detailed flowchart of the present invention when server 230 seeks to conduct a search. As shown, processing begins in step 410 when one or more devices 5 register with server 230. To register with a server a device simply transmits a position data update to server 230. Once server 230 receives a position data update, it then has a current position and identity of each device capable of participating in the search. Processing then flows to step 420 where server 230 defines the search area. If the search coordinates (latitude/longitude) are known, they may be entered into server 230 by the search coordinator. If the area to be searched is not linear, or the coordinates not known, a device 5 may be used to trace the outer perimeter of the search area and transmit the coordinates back to server 230. As server 230 receives the coordinates, it may output them on a display associated with server 230 for viewing by the search coordinator. Processing next flows to step 430 where the search coordinator defines the granularity of the search. For the purposes of this description, the granularity is the distance between adjacent search-and rescue devices 5. If the search involves a ship lost at sea, the granularity may be set a 1 mile. On the other hand, if the search is for a handgun used in a crime, the granularity may be 10 feet. Once the granularity is set and the searchers are positioned, processing flows to step 440 and the search is conducted.

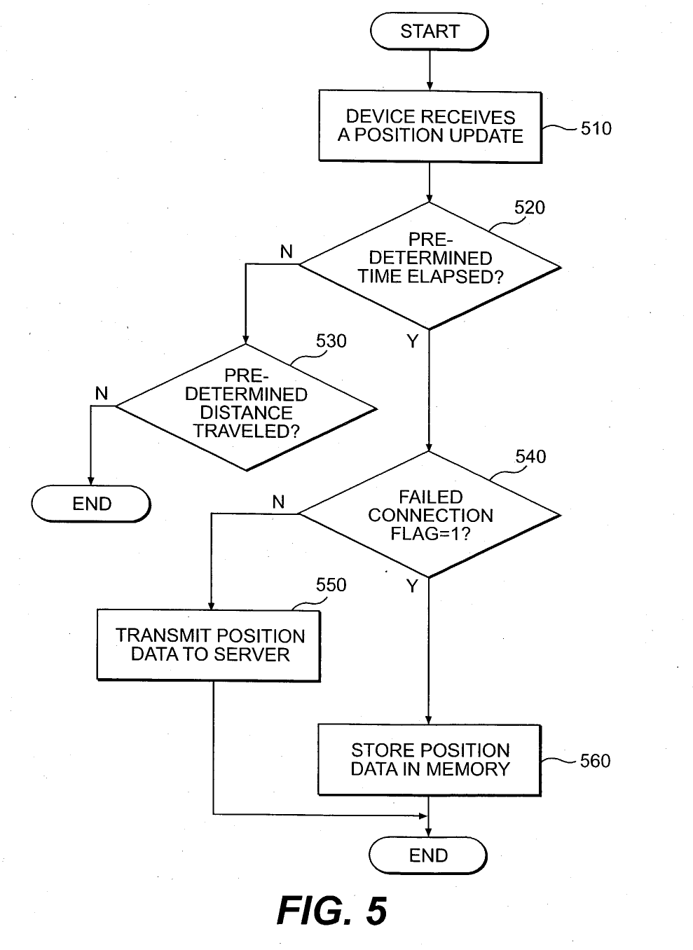

Turning now to FIG. 5, there is shown a detailed flowchart of the process performed by the present invention when search-and-rescue device 5 receives a position update from one or more GPS satellites 200. When search-and-rescue device 5 receives a position update (step 510), processing flows to step 520 where the device determines whether a predetermined time period has elapsed since the previous update was transmitted to server 230. If the predetermined period has elapsed, processing flows to step 540. If the predetermined period has not elapsed, processing flows to step 530. In step 530, the device determines whether the searcher has traveled a predetermined distance since the last position updated was transmitted. If the searcher has traveled the predetermined distance, processing flows to step 540. If the predetermined distance has not been traveled, processing terminates. In step 540, the device determines whether the failed connection flag=1. If the failed connection flag=1, then a connection to wireless network 180 (FIG. 1) has not been established, and processing flows to step 560. In step 560, the device stores the position data in memory 70, and then processing terminates. In one embodiment, device 5 will store the position data in memory 70 and then attempt to establish a connection to wireless network 180 prior to terminating processing. In a second embodiment, device 5 will store position data in memory 70 for a predetermined period of time before attempting to establish a connection to wireless network 180. In either event, device 5 will sequentially store position data in memory 70 until a connection is established with wireless network 180, at which time the position data in memory 70 will be transmitted. In the event all storage locations in memory 70 are filled during a period when device 5 is not in communication with wireless network 180, one embodiment of the present invention will continue to store new position data in memory by overwriting the oldest position data with current position data values. If the failed connection flag is not equal to 1, then a connection to wireless network 180 has been established and processing flows to step 550, where the device creates a position data packet and transmits it to network 180. Network 180 identifies the destination of the data, and in the case of server 230 or user terminal 250, 252 or 254, network 180 transmits the data to network 220. Network 220 then communicates the data through network service provider 240 to server 230, or user terminal 250, 252 or 254. When server 230 receives the position data, associates it with other data received from the same search-and-rescue device 5 and then displays the results on a display associated with server 230. Regardless of the elapsed time period or the distance traveled, one embodiment of the present invention will always transmit the first position update received after the device is turned on.

In one embodiment, processor 60 is configured to format a position data update as a User Datagram Protocol (“UDP”) packet and transmit it to wireless communication system 180. Processor 60 is further configured to add an identification code to the position data and transmit the identification code along with the position data. When the packet is received at server 230, the identification code is identified by server 230, enabling the position data to be associated at server 230 with the other data transmitted by the specific search-and-rescue device 5.

Each device 5 involved in the search periodically transmits position and identification data back to server 230. As server 230 receives position data, it associates it with the appropriate device 5 and updates a display accordingly. As the search proceeds, the search coordinator may transmit messages to device 5 to modify the traveling direction of one or more searchers. More specifically server 230 may transmit a poll message to device 5 to request an immediate position update be determined and transmitted from search-and-rescue device 5 to server 230. Server 230 may also transmit a configuration message to device 5 to change and reload the setup parameters stored in memory 70. A configuration message may also allow a search coordinator to change and reload the setup parameters in order to change the interval at which data is transmitted from device 5 to server 230. A configuration message may additionally transmit an inquiry from server 230 regarding the current configuration of parameters stored in memory 70.

When data is received by wireless phone 110, processor 60 will process the data message based on the type of data message received. For a poll message, processor 60 will send the current GPS position of the searcher. For a configure message, processor 60 will load the new configuration message which may include server 230 IP and port address, dial rate, hang time, speed trigger or time and distance reporting rates. For a configure inquiry message, processor 60 will send the current configuration requested which may include server 230 IP and port address, dial rate, hang time, speed trigger or time and distance reporting rates. After processing the received data message, processor 60 returns to read and process GPS data.

If no data message is received from wireless phone 110 while search-and-rescue device 5 is connected, processor 60 reads and processes GPS data from GPS receiver 40. After processor 60 processes GPS data, processor 60 checks if there are stored GPS positions or if GPS positions are queued based on setup parameters. If GPS positions are stored or queued, processor 60 sends the positions via wireless phone 110 to server 230 based on IP and port addresses in the setup parameters. After sending GPS positions, processor 60 checks if search-and-rescue device 5 should stay connected to wireless phone 110. Based on setup parameters, processor 60 will close the phone connection if appropriate or continue to stay connected and process positions triggers. If position triggers occur, processor 60 will return to read and process GPS Data and then send a GPS position. If position triggers have not occurred, processor 60 will return to read and process data from wireless phone 110.

In one embodiment, device 5 may also exchange text messages with server 230, user terminals 250, 252 and 254, and other search-and rescue devices over network 220, particularly when second module 20 and third module 30 use a Bluetooth Chipset. Typical examples of data transmitted by device 5 include the names of geographic features being traversed by the searcher, descriptions (such as addresses, buildings or other observable descriptors), the presence of features (such as holes, trees, steep inclines/declines, etc.), the character of the area (e.g., dense foliage, marsh, rocky, etc.), and any noteworthy items found along the way (e.g., debris, “hot spots,” the object of the search, etc.) Typical examples of data transmitted by server 230 include commands for altering the path traveled by a particular searcher. For example, when server 230 receives a position update from device 5, it may evaluate the position of device 5 in relation to the device nearest to it. Server 230 may then autonomously communicate correction data to one or more devices 5, or server 230 may communicate the calculated information to a search coordinator who may then communicate the information to one or more devices. When a noteworthy item has been discovered, the search coordinator may communicate this fact to the other devices, causing them to terminate the search, change the focus of their search, or change the path they will travel.

From the foregoing description, it will be appreciated that the present invention provides an efficient system and method for providing a personalized portal to a prospect. The present invention has been described in relation to particular embodiments, which are intended in all respects to be illustrative rather than restrictive. Those skilled in the art will appreciate that many different combinations of hardware will be suitable for practicing the present invention. Many commercially available substitutes, each having somewhat different cost and performance characteristics, exist for each of the components described above.

Despite the fact that aspects of the present invention are described as being stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, the method of the present invention may conveniently be implemented in program modules that are based upon the flow charts in FIGS. 3, 4, and 5. No particular programming language has been indicated for carrying out the various procedures described above because it is considered that the operations, steps and procedures described above and illustrated in the accompanying drawings are sufficiently disclosed to permit one of ordinary skill in the art to practice the instant invention. Moreover, there are many computers and operating systems, which may be used in practicing the instant invention and, therefore, no detailed computer program could be provided which would be applicable to these many different systems. Each user of a particular computer will be aware of the language and tools which are most useful for that user's needs and purposes.

Alternative embodiments will become apparent to those skilled in the art to which the present invention pertains without departing from its spirit and scope. Accordingly, the scope of the present invention is defined by the appended claims rather than the foregoing description.

What is claimed is:

1. A method for performing a search operation, comprising:
establishing a wireless connection between at least one of a plurality of search-and-rescue devices and a server;
transmitting data from a first search-and-rescue device to the server;
processing the data at the server; and
transmitting a request to the first search-and-rescue device to alter a direction of travel, in response to the data received.

2. The method of claim 1, wherein transmitting further comprises transmitting a request from the server to the first search-and-rescue device.

3. The method of claim 1, wherein transmitting further comprises transmitting a request from a second search-and-rescue device to the first search-and-rescue device.

4. The method of claim 1, wherein processing further comprises updating a display associated with the server to reflect a location of the first search-and-rescue device in relation to at least a second search-and-rescue device.

5. The method of claim 1, wherein processing further comprises updating a display associated with the server to reflect a location of the first search-and-rescue device in relation to a search perimeter.

6. The method of claim 5, wherein processing further comprises determining that the first search-and-rescue device is too close to a second search-and-rescue device.

7. The method of claim 5, wherein processing further comprises determining that the first search-and-rescue device has crossed the search perimeter.

8. The method of claim 1, wherein the data is position data.

9. The method of claim 1, wherein the data is a text message.

10. The method of claim 9, wherein the text message indicates that an item being searched for has been found.

11. An apparatus for performing a search operation, comprising:
means for establishing a wireless connection between at least one of a plurality of search-and-rescue devices and a server;
means for transmitting data from a first search-and-rescue device to the server;
means for processing the data at the server; and
means for transmitting a request to the first search-and-rescue device to alter a direction of travel, in response to the data received.

12. The method of claim 11, wherein the means for transmitting further comprises transmitting a request from the server to the first search-and-rescue device.

13. The method of claim 11, wherein the means for transmitting further comprises transmitting a request from a second search-and-rescue device to the first search-and-rescue device.

14. The method of claim 11, wherein the means for processing further comprises updating a display associated with the server to reflect a location of the first search-and-rescue device in relation to at least a second search-and-rescue device.

15. The method of claim 11, wherein the means for processing further comprises updating a display associated with the server to reflect a location of the first search-and-rescue device in relation to a search perimeter.

16. The method of claim 15, wherein the means for processing further comprises determining that the first search-and-rescue device is too close to a second search-and-rescue device.

17. The method of claim 15, wherein the means for processing further comprises determining that the first search-and-rescue device has crossed the search perimeter.

18. The method of claim 11, wherein the data is position data.

19. The method of claim 11, wherein the data is a text message.

20. The method of claim 19, wherein the text message indicates that an item being searched for has been found.

21. A computer-readable medium containing instructions executable by a computer for performing a search operation, the method comprising:
establishing a wireless connection between at least one of a plurality of search-and-rescue devices and a server;
transmitting data from a first search-and-rescue device to the server;
processing the data at the server; and
transmitting a request to the first search-and-rescue device to alter a direction of travel, in response to the data received.

22. The computer-readable medium of claim 21, wherein transmitting further comprises transmitting a request from the server to the first search-and-rescue device.

23. The computer-readable medium of claim 21, wherein transmitting further comprises transmitting a request from a second search-and-rescue device to the first search-and-rescue device.

24. The computer-readable medium of claim 21, wherein processing further comprises updating a display associated with the server to reflect a location of the first search-and-rescue device in relation to at least a second search-and-rescue device.

25. The computer-readable medium of claim 21, wherein processing further comprises updating a display associated with the server to reflect a location of the first search-and-rescue device in relation to a search perimeter.

26. The computer-readable medium of claim 25, wherein processing further comprises determining that the first search-and-rescue device is too close to a second search-and-rescue device.

27. The computer-readable medium of claim 25, wherein processing further comprises determining that the first search-and-rescue device has crossed the search perimeter.

28. The computer-readable medium of claim 21, wherein the data is position data.

29. The computer-readable medium of claim 21, wherein the data is a text message.

30. The computer-readable medium of claim 29, wherein the text message indicates that an item being searched for has been found.
